(19) United States
(12) Patent Application Publication
(10) Pub. No.: US 2012/0228472 A1
(43) Pub. Date: Sep. 13, 2012

(54) High Strength Optical Window For Radiation Detectors

(76) Inventors: John J. Simonetti, Hamilton, NJ (US); Donna Simonetti, Hamilton, NJ (US); Christian Stoller, Princeton Junction, NJ (US); Albert Hort, Mount Laurel, NJ (US); Edward Durner, Cranbury, NJ (US)

(21) Appl. No.: 13/321,567

(22) PCT Filed: May 18, 2010
(86) PCT No.: PCT/US2010/035223

§ 371 Date: May 21, 2012

Related U.S. Application Data
(60) Provisional application No. 61/180,225, filed on May 21, 2009.

(51) Int. Cl. H01J 43/28; G01T 1/20; G01J 1/58

(52) U.S. Cl. 250/207; 250/485.1; 250/368

(57) ABSTRACT

The invention provides a hermetically sealed scintillation crystal package with a window made of a ruggedized material such as ALON (aluminum Oxynitride) or Spinel ceramic (MgAl₂O₄) where the window is sealed to an external metallic housing part by a brazing or soldering process and the external housing part is welded to the housing containing the scintillation crystal.

### RELATED APPLICATIONS

The present application claims priority to U.S. Provisional Patent Application Ser. No. 61/180,225 filed May 20, 2009.

### BACKGROUND

Many useful scintillator materials like NaI(Tl) require protection from environmental stress before they can be assembled into a radiation detector. This is particularly true when the scintillation detector is applied to well logging. Such protection from direct exposure to air by enclosing the scintillator in a hermetically sealed container as described in U.S. Pat. No. 4,764,677.

A block diagram for a typical scintillator package is shown in FIG. 1. A scintillator crystal 102 is wrapped or otherwise surrounded by one or more layers of a preferably diffuse reflector material 103 that is preferably formed from a fluorocarbon polymer. The wrapped crystal 102 can be inserted in a hermetically sealed housing 104 which may already have the optical window 106 attached. The window 106 may be sapphire or glass, as noted in U.S. Pat. No. 4,360,733. The housing 104 may then be filled with a room-temperature vulcanizing (RTV) silicone that fills the space between the crystal 102 and the inside diameter of the housing 104. Optical contact between the scintillator crystal 102 and the window 106 of the housing 104 is established using an internal optical coupling pad 108 comprising a transparent silicone rubber disk. A wave spring 110 and pressure plate 112 hermetically seal the end opposite the window 106.

The scintillator package includes an optical window 106 to provide for efficient transmission of the scintillation light produced in the scintillator to a photomultiplier or an equivalent device such as an avalanche photodiode (APD), Si-photomultiplier, Hybrid PMT, MCP-based PMT. An analogous window of the PMT (shown in FIG. 2) is typically constructed using a glass or single crystal sapphire but other materials may be considered that provide better transparency, higher strength and lower cost.

In the typical construction of an optical window in a scintillator package and/or PMT, the transparent material is joined to a metal frame. The metal frame is then typically welded to the housing of the device to form a gas tight seal. A radiation detector consists of both the scintillator package and the PMT. Both require the use of a hermetic window assembly with good transmission efficiency over the range of wavelengths of the scintillator material emission.

A typical radiation detector assembly is shown in FIG. 2. Specifically, FIG. 2 illustrates the scintillation detector of FIG. 1 coupled to the entrance window 204 of the PMT 202 by an external optical coupling layer 206 to optimize the transmission of the light from the scintillator 102 (through the optical coupling pad 108 and the scintillator window 106) to the PMT 202. It should be noted that it is also possible to mount a scintillator 102 directly to the PMT 202 with only a single optical coupling (thereby eliminating optical coupling 210 and scintillator window 208) and providing the combination of PMT 202 and scintillator 102 into a single hermetically sealed housing. The scintillator crystal 102 may receive gamma rays such as from hydrocarbons in formations, and this energy may cause electrons in one or more activator ions (if present in the scintillator, as not all scintillators include activators but rather are intrinsic) in the scintillation material to rise to higher energy level. The electrons may then return to the lower or “ground” state, causing an emission of an ultraviolet ray. As noted, the PMT and scintillator package could have a sapphire or glass window as is known to those skilled in the art. The PMT 202 includes spaced apart photocathode 208 and anode 209, having a series of dynodes 210 located therebetween, within the composite shell 212. The high voltage used to operate can be applied either to the photocathode or the anode in way that are well known in the art.

### BRIEF DESCRIPTION OF THE DRAWINGS

FIG. 1 is a block diagram showing a typical scintillator package;

FIG. 2 is a block diagram showing a typical well logging detector with sapphire window containing photomultiplier tube (PMT);

FIG. 3 shows crystal housings with sealed windows;

FIG. 4 is a block diagram showing a PMT integrated with hermetically sealed scintillator; and

FIG. 5 shows a partial crystal structure of LaX3 lattice.

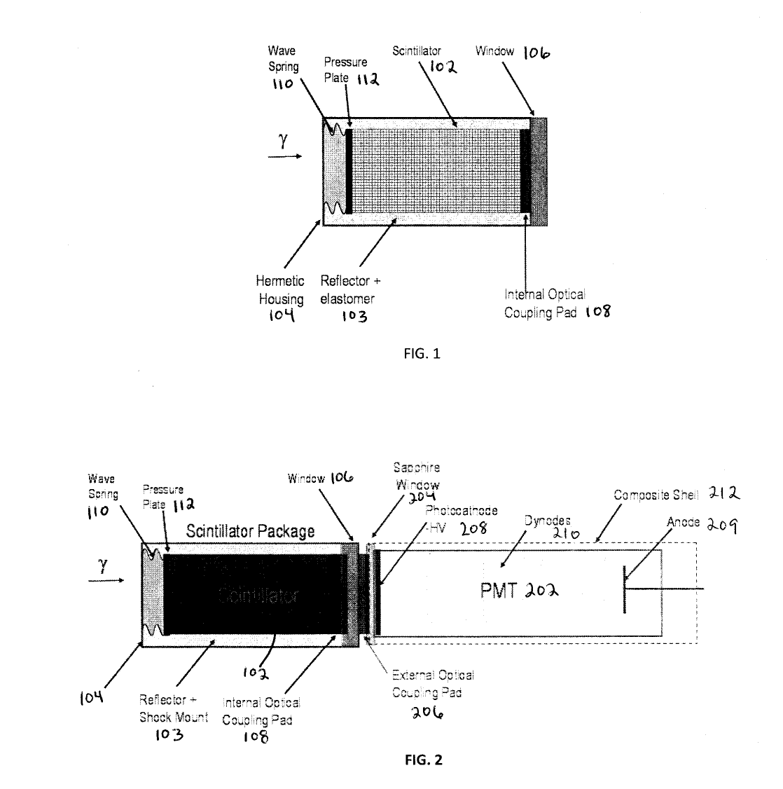

### DETAILED DESCRIPTION

In the following description, numerous details are set forth to provide an understanding of the present disclosure. However, it will be understood by those skilled in the art that the present invention may be practiced without these details and that numerous variations or modifications from the described embodiments are possible.

It is possible to improve detector performance, and in some cases, reduce cost by application of other, relatively new, optical materials. These include the polycrystalline ceramics AlON (Aluminum Oxynitride) and Spinel (MgAl₂O₄). Both materials provide higher mechanical strength than the classical window materials and reduced cost. The use of MgF₂ is also considered here as a means of providing excellent transmission of shorter wavelength light than would be possible using the conventional window material choices like glass or sapphire.

Not all scintillator materials that require packaging are isotropic like the cubic crystal NaI(Tl). Among the two rather new materials that fall into this anisotropic category are LaCl₃:Ce and LaBr₃:Ce. These materials have a UC13 crystal type that is essentially hexagonal and this requires special consideration when packaging. The anisotropic structure translates directly to a notable difference in thermal expansion along the different crystallographic axes. As reported in Structure and properties of Ianthanide halides, Proc. SPIE Vol 6707 670705 (2007) by F. P. Dorty, Douglas McGregor, Mark Harrison, Kip Findley, and Raulf Polichur, the thermal expansion coefficient in the c-Axis direction was measured as 7.5×10._{—}⁶/° C. The magnitude of this value is not unusual. However, the expansion coefficient orthogonal to the c-axis is 3.8 times greater. The substantial differential expansion makes these materials sensitive to fractures particularly during heating and cooling as is common in oilfield applications. Packaging of the lanthanum compounds in a particular orientation would provide an advantage for preserving the integrity of the crystals during thermal excursions.

When assembling a radiation detector specifically intended for use in oilfield well logging a great advantage is gained by using intrinsically rugged materials. This is particularly true for the hermetic package required to protect many scintillator materials that include NaI(Tl), CsI(Tl), CsI(Na), LaBr₃:Ce, LaCl₃:Ce and the like. In addition, the window of a PMT used to detect the scintillation light must also be of a rugged design. A typical radiation detector assembly is shown in FIG. 2, and discussed above. Those familiar with the art have employed glass and occasionally sapphire for this application. The joint between the metal frame and the sapphire must also be robust. Active metal brazing is preferred but other seal mechanisms may be applicable for both the PMT and hermetic scintillator package. A different approach using a glass frit is shown in Saint Gobain patent application U.S. 2007/0007460.

Sapphire is usually supplied as a single crystal product but because its crystal structure is hexagonal, it is oriented so that the “c” axis is aligned with the window axis to maximize mechanical strength. Generally, such oriented sapphire product is referred to as “zero degree sapphire.” It is preferred for the most demanding applications and is more expensive. The oriented sapphire disk is then brazed into a metal frame usually made from an expansion matched metal alloy such as KOVAR™ (Kovar is a trademark of Carpenter Technologies). The alloy is more generally referred to ASTM F-15 alloy. It may also be brazed or solder joined to a metal alloy such as stainless steel or Ti alloy by imposing a stress relief washer between the sapphire surface and the metal window frame. The stress relief washer is often made from a highly ductile metal like fully annealed Ag, Cu or Ni. This approach to joining minimizes residual stress on the brittle window material and thus preserves maximum resistance to externally applied forces. The braze alloy generally contains a reactive metal such as Ti, Zr or a rare earth element such as Ce to promote wetting of the sapphire by the braze alloy. It is also possible to thin film metalize the sapphire edges prior to joining them to the metal frame with a solder alloy. Metallizing consists of a base layer of Cr, Ti, Zr, Hf, Ta, Nb or an alloy containing these elements followed by at least one layer to promote solder alloy wetting which may include Cu, Ni or Au or an alloy containing these elements. A typical metal layer is between 1000 Å and 20000 Å in thickness. Metalizing is applied by any thin film deposition method commonly available including evaporation, sputtering or chemical vapor deposition. Finally, a thick film metalizing process may be applied to the sapphire window edge that would essentially provide a direct bond to the sapphire and present a metal surface suitable for brazing. This Mo/Mn metalizing is known to those skilled in the art.

There are optical materials with superior mechanical or optical properties that are preferable over the commonly used glass or sapphire for use in extreme conditions. Two materials for extreme resistance to mechanical forces would be ALON (aluminum Oxynitride) and Spinel Ceramic (MgAl₂O₄). Such materials have higher impact strength than sapphire and have the added advantage of an isotropic cubic structure as noted in an article by: Mark C. L. Patterson, Anthony DiGiovanni, Don W. Roy, Gary Gilde in the American Ceramics Soc. 27^{th} Conference on Advanced Ceramics and Composites, January 2003.

ALON can be hermetically joined directly to a KOVAR frame for PMTs that could be employed in radiation detectors specific for well logging while drilling (LWD). The hermetic joint is accomplished by active metal brazing but other joining methods as described for sapphire may also be appropriate. Spinel may also be employed in a similar manner as direct substitute for either sapphire or ALON. Both ALON and Spinel Ceramic may be used as a PMT window or as an optical window for a hermetically sealed scintillator package. In the design disclosed here, the window is joined at the edges to a metal frame made from an expansion matched alloy which is then fusion welded to the metal housing. The joint between the window and the frame and the joint between the frame and the housing are both hermetic.

Some scintillation materials may also exhibit a very short wavelength of scintillation emission that would benefit from the use of a much more transparent material for the window of the scintillator package. These materials include LiYF₄; Tm, LiYF₄:Er, YF₃:Gd and LiLuF₃ and also LuAG:Pr, which has emission down to 310 nm. A similar technology has been in use for some time for PMTs (see, e.g., U.S. Pat. No. 3,662,206). The low refractive index and extremely good transmission of light to 115 nm would be beneficial. MgF₂ is not as strong as most optical materials and so would require some care in use, but offers good chemical compatibility with most environments compared to other high transmission window materials. The window design is modified for use in packaging since the window will need to sustain internal forces pressing outward. Thin film metalizing would be an appropriate method for developing a window bond. In this case, a thin Ag or Pt film would be applied to the window edges by a physical vapor deposition technique. A multilayer thin film edge metallization could alternatively be applied for solder sealing to a metal frame. A thick film coating for metalized bonding is possible. This might include Ag for an AgCl seal. While LuAg:Pr can be used with a photomultiplier equipped with a sapphire window, it can benefit from the better optical properties of MgF₂ because of its short emission wavelength of about 310 to 370 nm.

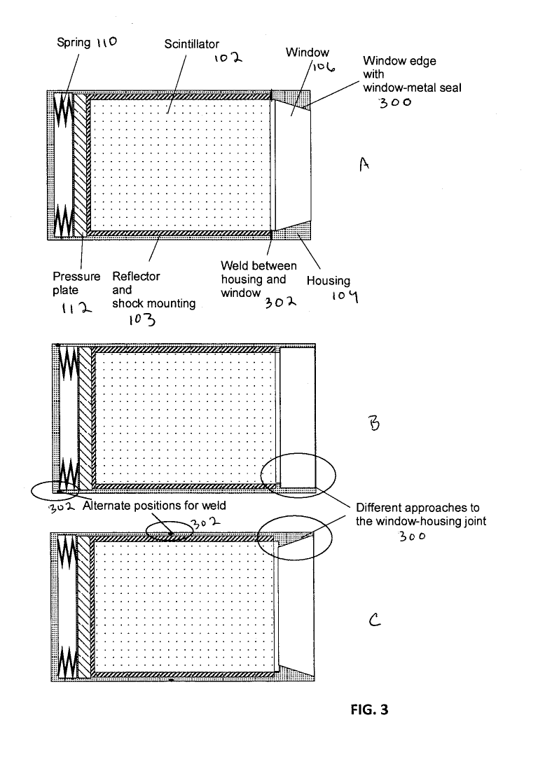

FIGS. 3A-C show schematic views of a sealed window on a hermetic scintillator package. Different shapes for the window edge are possible. Three approaches are shown: a window wider at the weld side of the window than the external side of the window (as in FIG. 3A), a window of substantially uniform internal and external sides (as in FIG. 3B), and a window wider at the external side of the window than at the weld side of the window (as in FIG. 3C). More complicated shapes can be envisaged, such as steps in the windows or curved edges. Also shown are possible locations for the welds that are needed to combine the sealed window assembly with the rest of the housing. If brazing is used for attaching the window, brazing can be performed in a separate step because of the high temperatures involved. One approach encompasses the window being sealed using a high temperature epoxy or similar. Applying epoxy to eliminate the weld is possible when the opening at the front allows insertion of the crystal assembly. Epoxy seals have traditionally been found to be unreliable for downhole tools.

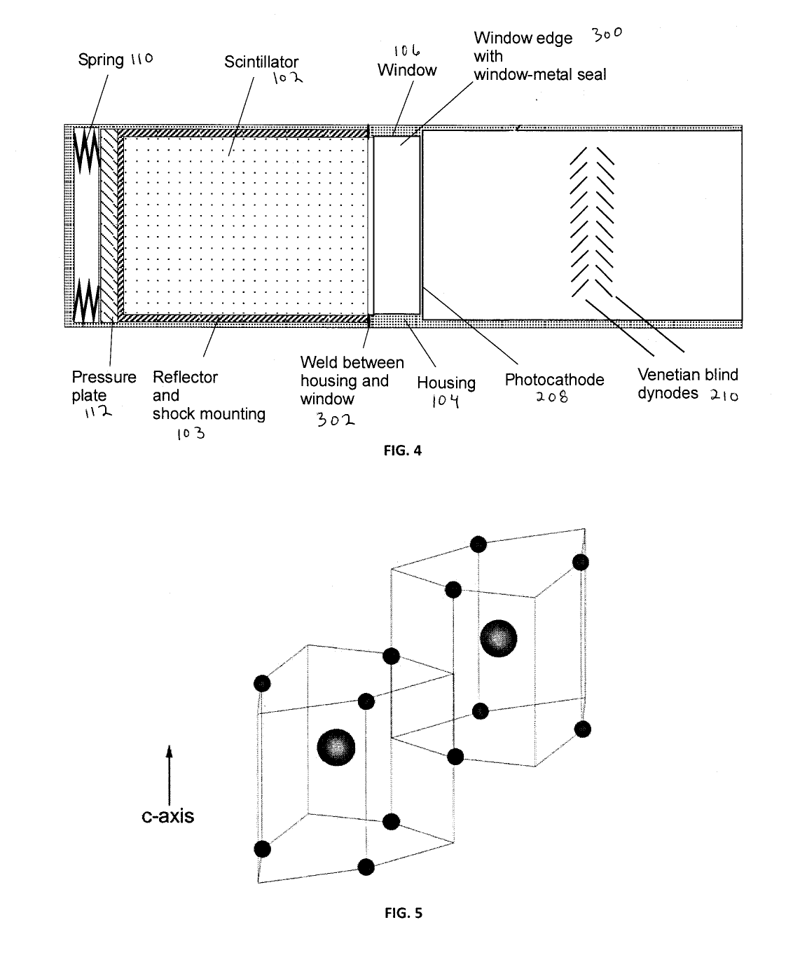

The approach described above is also suitable for making an integrated scintillator-PMT package in which there is only a single window, i.e. the PMT entrance window is the scintillator exit window as shown in FIG. 4. FIG. 4 is an alternative embodiment to that shown in FIG. 2.

In this case, a metal with high magnetic permeability could be used as the housing material, making it possible to integrate packaging and magnetic shielding at the same time, and eliminate the need for a separate external magnetic shield. The assembly is thus simpler and reduces the radial dimensions of the package. The high permeability material could be AD-MU 80 from Advance Magnetics, Inc.

It is now understood that the physical properties of the two recently introduced scintillator materials LaBr₃:Ce and LaCl₃:Ce are determined by the crystal structure, which is not isotropic. The structure of their crystal lattice is shown in FIG. 5, from an article by F. P. Dorty, Douglas McGregor, Mark Harrison, Kip Findley, Raulf Polichur and Pin Yang Mater. Res. Soc. Proc. Symp. Vol. 1038 2008. (As shown in FIG. 5, the halide ions are shown as small spheres not drawn to scale).

Slip in the structure can take place primarily between the shared faces along the c axis. The process of slip initiates fractures that will eventually result in internal light scattering and degraded performance of the scintillator. The fractures can initiate upon application of external mechanical force or by producing thermal gradients. In isotropic media, thermal gradients result in uniformly applied stress because the lattice expands the same in all directions. However, in the complex structure of LaX₃, thermal expansion is not uniform and depends strongly on the lattice direction. It is generally known that thermal conductivity of Chloride, Bromide and Iodide salts is poor and so large thermal gradients develop quickly. The anisotropic forces that are developed by thermal expansion result in brittle failure.

Thus we can precisely align the weak crystallographic direction “c axis” so that uniformly compressive forces can be applied during packaging. Such alignment provides some relief from the stress that will develop during heating or from externally applied mechanical acceleration. The orientation of a crystal before packaging is complicated by the fact that crystal growth for the La-halide scintillators mentioned above is accomplished by the Bridgeman method which does not strictly control crystal orientation. If the final shape of the scintillator is a cylinder, it would need to be cut from the grown ingot so that the cylinder geometry is either axial or radial with respect to the crystal axis.

If the crystal is aligned with the c-axis parallel to the cylinder, the crystal can be uniformly preloaded in a particular orientation using the spring in the package to compress the scintillator crystal. It may be preferable to align the crystal axis with the radial direction of the cylinder. In this case, force could be applied evenly onto the curved walls of the cylinder to uniformly compress the crystal along this c-axis. Radial compression is achieved by pouring a uniform layer of liquid RTV silicone cured into an exactly conforming elastic covering. In some embodiments, the silicone is applied after the crystal is inserted into the housing. In some embodiments, the crystal is wrapped with a reflective layer then lowered into the tubular metal housing with the window attached. Once the reflector wrapped crystal is loaded and centered in the tubular housing, the annular space between the reflector wrapped crystal and the inside diameter of the housing are filled with liquid RTV silicone resin. RTVs that cure by the addition cure reaction mechanism are preferred in which a vinyl substituted silicone polymer is reacted with a silane cross linking agent in the presence of a Pt catalyst. Gelest™ PP2-OE41 is preferred but Dow Corning Sylgard® 182, 184 or 186 could be used.

The RTV silicone surrounding the crystal is also used to mitigate the development of thermal gradients. The RTV silicone is more able to minimize thermal gradients if thermally conductive. Thus, various fillers can be added to the silicone to increase the thermal conductivity. Fillers may include BN, AlN, ZnO, or finely divided metal such as Al, Ag or Cu. If uniform sudden external temperature changes are anticipated over the package surface, the scintillator is insulated from these changes by using a cellular silicone which also has viscoelastic properties. In some embodiments, a RTV silicone is filled with glass microspheres to further reduce the thermal conductivity. Glass bubbles can be obtained from Trelleborg Emerson Cummings Inc., under the name of Eccospheres™. The glass bubble approach is useful for reducing the occurrence of thermally induced fractures in crystals with larger dimensions beyond 1″ diameter. Methods for thermal protection are also listed in the following prior provisional applications Ser. No. 61/104,115 (Attorney Docket No. 49.0393), Ser. Nos. 61/160,416 and 61/160,746 (Attorney Docket No. 49.0414) and Ser. No. 61/160,734 (Attorney Docket No. 49.0403).

While the invention has been disclosed with respect to a limited number of embodiments, those skilled in the art, having the benefit of this disclosure, will appreciate numerous modifications and variations therefrom. It is intended that the appended claims cover such modifications and variations as fall within the true spirit and scope of the invention.

What is claimed is:

1. A hermetically sealed scintillation crystal package, comprising:
a scintillator crystal;
a first housing provided to enclose said scintillator crystal;
a window comprising a material selected from the group comprising aluminum Oxynitride (ALON), Spinel ceramic (MgAl₂O₄) and MgF₂;
wherein the window is sealed with a seal to an external metallic housing by a process selected from the group comprising brazing and soldering; and
wherein the external metallic housing is welded to the first housing.

2. The package of claim 1, wherein the scintillator comprises a crystal material selected from the group comprising NaI(Tl), LaBr₃:Ce, LaCl₃:Ce, another La-halide, CsI(Tl) and CsI(Na).

3. The package of claim 1, wherein the scintillator comprises a crystal material selected from the group comprising LiYF₄;Tm, LiYF₄:Er, YF₃:Gd and LiLuF₃ and the window material comprises MgF₂.

4. The package of claim 1, wherein the first housing comprises a stainless steel alloy.

5. The package of claim 1, wherein the first housing comprises a Ti alloy.

6. The package of claim 1, where the seal couples at least two materials of matched coefficients of thermal expansion.

7. The package of claim 1, wherein the seal couples at least two materials having mismatched coefficients of thermal expansion.

8. The package of claim 7, further comprising a stress relief washer between the two mismatched materials.

9. The package of claim 1, wherein the window is joined to the external metallic housing by an active metal brazing process.

10. The package of claim 1, wherein the window is joined to the external metallic housing by a soldering process.

11. A photomultiplier, comprising:
A photomultiplier body; and
a window comprising a material selected from the group consisting of ALON (aluminum Oxynitride) and Spinel ceramic (MgAl₂O₄);
wherein the window is sealed to the body of the photomultiplier by means of a process selected from the group comprising brazing and soldering.

12. An integrated scintillator-photomultiplier package, comprising:
a scintillator housing;
a package body comprising a window, the window being formed from ALON (aluminum Oxynitride) or Spinel ceramic (MgAl₂O₄);
a seal coupling the window is sealed to the package body, the seal being created by a process selected from the group comprising brazing and soldering; and
wherein the scintillator housing is substantially permanently coupled to the package body of the photomultiplier.

13. The integrated scintillator-photomultiplier package of claim 12, where the scintillator comprises a material selected from the group comprising NaI(Tl), LaBr₃:Ce, LaCl₃:Ce, other La-halides, CsI(Tl) and CsI(Na).

14. The integrated scintillator-photomultiplier package of claim 12, wherein the scintillator housing comprises a stainless steel alloy.

15. The integrated scintillator-photomultiplier package of claim 12, wherein the scintillator housing comprises a Ti alloy.

16. The integrated scintillator-photomultiplier package of claim 12, wherein the package body comprises a material having a high magnetic permeability.

17. The integrated scintillator-photomultiplier package of claim 16, wherein the package body comprises AdMu-80.

18. The integrated scintillator-photomultiplier package of claim 12, wherein the seal couples two materials having matched coefficients of thermal expansion.

19. The integrated scintillator-photomultiplier package of claim 12, where the seal couples two materials having mismatched coefficients thermal expansion.

20. The integrated scintillator-photomultiplier package of claim 19, further comprising a stress relief washer between the two materials having mismatched coefficients thermal expansion.

21. The hermetically sealed package of claim 12 wherein the window is joined to the metal by means of an active metal brazing process.

22. The hermetically sealed package of claim 12 in which the window is joined to the metal by means of a soldering process.

23. A hermetically sealed scintillation crystal package, comprising:
an axially-symmetric scintillation crystal having a non-isotropic crystal lattice;
at least one cylinder, wherein one of the crystal axes is aligned in a first orientation with the axis of the axially-symmetric scintillation crystal;
a first housing provided to enclose said scintillator crystal;
a window comprising a material selected from the group comprising aluminum Oxynitride (ALON), Spinel ceramic (MgAl₂O₄) and MgF₂;
wherein the window is sealed with a seal to an external metallic housing by a process selected from the group comprising brazing and soldering; and
wherein the external metallic housing is welded to the first housing.

24. The hermetically sealed scintillation crystal package of claim 23, further comprising a filler material disposed about the scintillation crystal, the filler material comprising a room-temperature vulcanizing resin cured in place about the scintillation crystal.

25. The hermetically sealed scintillation crystal package of claim 25, wherein the resin comprises a thermally conductive filler selected from the group comprising BN, AN, ZnO, a finely divided metal, Al, Ag, and Cu.

26. The hermetically sealed scintillation crystal package of claim 23, wherein the scintillator comprises a material selected from the group comprising LaBr₃, LaCl₃ and a generic La-halide.

27. The hermetically sealed scintillation crystal package of claim 23, wherein the scintillation crystal is oriented such that a c-axis of the scintillation crystal lies substantially parallel to the axis of the scintillation crystal cylinder.

28. The hermetically sealed scintillation crystal package of claim 27, wherein the scintillator is compressed along the c-axis.

29. The hermetically sealed scintillation crystal package of claim 28 wherein the crystal is compressed radially with an elastic material positioned about the crystal to reduce stress in a direction perpendicular to the c-axis.

30. The hermetically sealed scintillation crystal package of claim 23, wherein the scintillation crystal is oriented such that a c-axis of the scintillation crystal lies substantially perpendicular to the axis of the scintillation crystal cylinder.

31. The hermetically sealed scintillation crystal package of claim 30, wherein the scintillator is compressed along the axis.

32. The hermetically sealed scintillation crystal package of claim 31, wherein the scintillation crystal is compressed radially with an elastic material positioned about the crystal to reduce stress along the c-axis.
